(19) United States
(12) Patent Application Publication
(10) Pub. No.: US 2022/0358488 A1
(43) Pub. Date: Nov. 10, 2022

(54) NFT DIGITAL FRAME

(71) Applicant: Infinity Pieces Inc., Hermosa Beach, CA (US)

(72) Inventor: Michael Kidakarn, Lawndale, CA (US)

(21) Appl. No.: 17/739,034

(22) Filed: May 6, 2022

Related U.S. Application Data
(60) Provisional application No. 63/186,015, filed on May 7, 2021.

(51) Int. Cl. G06Q 20/36

(52) U.S. Cl. CPC G06Q 20/367; G06Q 2220/00

(57) ABSTRACT

A NFT digital frame comprises a display screen to display NFT digital assets cryptographically secured in a decentralized Blockchain before decryption, a scanning unit to scan tokens which the storage addresses of the digital assets are mapped into, and a processor to identify the tokens and retrieve the data from the decentralized Blockchain. The tokens are one-to-one corresponded to the digital assets exclusively, so that the NFT digital frame can access and display the NFT digital assets via an identification of the tokens and acquisition of the digital asset in the Blockchain.

### CROSS-REFERENCE TO RELATED APPLICATIONS

This non-provisional application claims priority under 35 U.S.C. § 119(a) on U.S. Provisional Patent Application No. 63/186,015 filed on May 7, 2021, the entire contents of which are hereby incorporated by reference.

### FIELD OF THE INVENTION

The present invention is in the field of accessing and displaying cryptographical digital assets and pertains particularly to a NFT digital frame and a method for displaying the digital assets.

### BACKGROUND OF THE INVENTION

With the development of Blockchain, the digital token technology is booming. Digital currency, a typical fungible token, has been prevailing in a hot topic within recent years. On the other hand, another digital token, different from the prior fungible token, is skyrocketing in the form of NFT (Non-fungible Token). NFTs are the newest way to trade collectibles, and encompass art forms ranging from digital art to GIFs to music and beyond. Thanks to the emerging technology upending the rules of digital ownership, NFTs—digital tokens tied to assets that can be bought, sold and traded—are enabling creators (i.e. artists, athletes, musicians, celebrities, famous persons, companies, estates of the deceased) to profit from their work more easily than ever. Essentially, anything that can be thought of to hold value and can be stored digitally can be sold as an NFT. Crucially, NFTs are part of the Blockchain so that the NFTs can be protected from counterfeiting. Accordingly, the creation and transaction of the digital assets have grown rapidly.

Likewise, a corresponding demand for development of displaying the digit artwork is urgent. Throughout the prior art, engineers or technicians have conceived some prototypes of displaying the digital artworks. A majority of displays or monitors installed with operation system, have been utilized to constantly display the digital pictures, photos, or even videos or audio.

A problem with current display devices is that they are not specialized with NFTs technology. The conventional digital image display is limited into the exhibition of common digital images or videos without any encrypt codes. Further, only if these images are transmitted or pre-stored into the display device, the device can display.

However, these tablets are expensive, multifunctional, and complicated in an inquiring operation via Internet.

Another flaw for the prior displays is that the prior display device is limited to present only one piece of artwork. For example, a digital frame is bonded with a built-in image or video, exactly served like a conventional wood frame, unable to change images presented on the screen.

Therefore, what is clearly needed is a digital frame customized for displaying NFTs digital assets secured cryptographically. A NFT digital display frame such as this would better display the digital assets in a quick-response (without a verification/account authentication over Internet or Server Protocol) and help the creators for exhibiting their creations smoothly.

### SUMMARY OF THE INVENTION

An aspect of the invention is to provide a NFT (Non-Fungible Token) digital frame, the frame comprising:
a display screen to display NFT digital assets, wherein the digital assets are cryptographically secured in a decentralized database;
a scanning unit to scan tokens, wherein storage addresses of the digital assets are mapped into the tokens; and
a processor to identify the tokens and retrieve the data from the decentralized database;
wherein, the tokens are one-to-one corresponded to the digital assets exclusively.

In one embodiment of the invention, the digital assets are selected from digital tokens, certificates, paintings, photographs, sculptures, GIFs, videos, audios, or the combination thereof.

In one embodiment of the invention, the decentralized database is Blockchain.

In one embodiment of the invention, the frame contains a power charge input.

In one embodiment of the invention, the tokens are selected from long alphanumeric strings, QR codes, or Barcodes.

In one embodiment of the invention, the scanning unit is selected from a built-in camera, QR or Barcode scanner, or handle gun-type scanner.

In one embodiment of the invention, further the frame connects with an external device.

In one embodiment of the invention, the connection between frame and external is selected from NFC, Bluetooth, Wi-Fi, cable, or a combination thereof.

In one embodiment of the invention, further the frame stores one or multiple digital assets, and display the digital assets in a loop on the screen.

In one embodiment of the invention, further the frame stores one or multiple digital assets, and display multiple digital assets simultaneously on split-screen.

In one embodiment of the invention, further the frame displays the biographical and transaction information of the digital assets on the screen.

In one embodiment of the invention, further the frame displays a digital calendar with automatically interchangeable background on the screen.

In one embodiment of the invention, further the frame integrates a transparent pyramid on the center of the screen to displays a holographic projection.

Another aspect of invention is to provide a method for acquisition of NFT (Non-Fungible Token) digital assets, the method comprising:
identifying a token of a cryptographical digital asset;
retrieving the corresponding digital asset;
accessing the digital asset; and
displaying of the digital asset.

In one embodiment of the invention, the identifying comprises scanning, typing, or sending the token of the digital asset to a processor.

In one embodiment of the invention, the retrieving includes a search in a decentralized database to locate the corresponding digital asset based on the identified token.

In one embodiment of the invention, the token one-to-one corresponds to the digital asset.

In one embodiment of the invention, the accessing includes decrypting the digital asset and obtaining the information thereof.

In one embodiment of the invention, the displaying includes presenting the digital asset, the information thereof, or combination on a display device.

In one embodiment of the invention, the display device is a NFT digital frame.

### BRIEF DESCRIPTION OF THE DRAWINGS

The invention will now be described, by way of example, with reference to the accompanying drawings, in which:

FIG. 1A is an illustration for an embodiment of realization of displaying a digital asset through scanning.

FIG. 1B is an illustration for an embodiment of realization of displaying a digital asset via typing input.

FIG. 1C is an illustration for an embodiment of realization of displaying a digital asset through a communication with an external device.

FIG. 2 is a diagrammatic illustration of a representative acquisition of a digital asset via scanning in accordance with an embodiment of the present invention.

FIG. 3 is a diagrammatic illustration of a representative NFT digital frame scanning from an external device, in accordance with an embodiment of the present invention.

FIG. 4 is a diagrammatic illustration of a representative NFT digital frame displaying digital calendar on the screen, in accordance with an embodiment of the present invention.

FIG. 5 is a diagrammatic illustration of a representative NFT digital frame hologram assembly displaying a holographic 3D object, in accordance with an embodiment of the present invention.

Like reference numerals refer to like parts throughout the various views of the drawings.

### DETAILED DESCRIPTION OF THE INVENTION

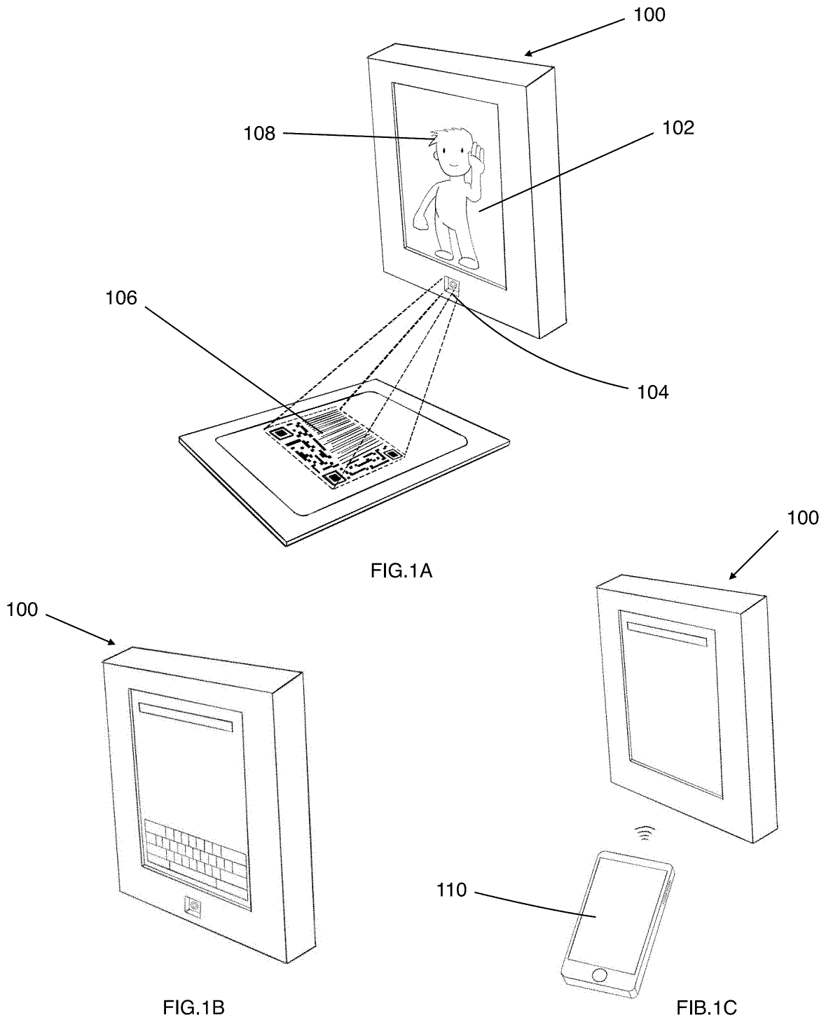

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

FIG. 1A-C are some diagrammatic illustrations of the NFT digital frame, in accordance with embodiments of the present invention. A NFT digital frame 100 in this embodiment is a hardware device that is able to access and display the digital assets via decentralized or blockchain technology. The frame 100 has a display screen 102 mounted in the center, surrounding by the edges; the frame 100 also has a scanning unit 104 mounted on a surface of the frame 100; the frame 100 also has a processor to read/write data from a decentralized database.

In this example, each of the digital assets stored in the decentralized database is referred to an exclusive and non-counterfeited address. Technically, the address is composed of a definite length of numbers and letters. When the address is requested or identified, the corresponded digital asset will be read, furtherly be displayed or viewed. Also, the digital frame can contain metal edges surrounding the screen, and a stand on its back to support itself on the platform.

In this example, the processor is used to read/write memory. Preferably, the processor controls the frame to identify the tokens and retrieve the data from the decentralized database.

In this example, the storage addresses of the digital assets in the decentralized database are mapped in relation to the token.

The scanning unit 104 may be selected from a built-in camera, QR or Barcode scanner, or even a handle gun-type scanner. The display screen 102 is touchable screen.

FIG. 1A is an illustration for an embodiment of realization of displaying a digital asset through scanning. Via scanning a token 106, the frame 100 is able to access and display a digital asset 108 on the screen 102. The token 106 is representative symbol in the forms of long digit strings, QR codes, Barcodes, etc. to visualize a storage address linked into Blockchain. The token 106 also may be presented in any scannable form, like printed on papers or cards or loaded on the screen of a device (i.e. a phone or a display).The digital asset 108 may be any type of cryptographically digital collectibles or artworks, including but not limited into digital tokens, certificates, characters, paintings, photographs, sculptures, GIFs, video, audio, or even any work created by creators. The digital asset 108 and information thereof has been stored or registered in Blockchain, instead of the Internet or Server. The token 106 is exclusively mapped/corresponded to the digital asset 108 in the blockchain database so that the cryptographically secured digital assets can be retrieved and accessed safely and accurately, wherein the token and the digital asset are only corresponded to each other.

FIG. 1B is an illustration for an embodiment of realization of displaying a digital asset via typing input. Users can input the access address of the digital asset via typing on the screen.

FIG. 1C is an illustration for an embodiment of realization of displaying a digital asset through a communication with an external device 110. The external device 110 may be selected from a phone or processors. The communication would be selected from a technology of NFC, Bluetooth, or Wi-Fi. Via the communication, the external device 110 sends the token address to the frame, and then the frame 100 can access to the digital asset in the decentralized database or system, preferably in Blockchain. In an alternatively example, the frame 100 may scan from the loaded token(s) on a phone or another display to access the digital asset.

Once retrieving and accessing the digital asset, the digital asset will be displayed on the screen of the frame 100. Preferably, via an acquisition and identification of token address, the frame 100 has unlocked all the relative encryption of the digital asset, and the users can view the digital visually. Take a digital photo as an example, once the token (i.e. in the form of QR Code) linked to the photo is scanned, the NFT scan digital frame 100 not only displays photo on the screen 102, but also optionally presents the photographic information including the photography date, resolution, lens, size, photographer, etc. Meanwhile, the presented information also may include registrations and transactions information, including the history of registration or transaction (trade date and price), platform, buyer, vendor, and certificate organization, ID identification, etc.

In another example characterized with a 3D artwork or video created digitally, once scanning the token 106, the frame 100 would exhibit the 3D artwork animatedly in different views or broadcast the video.

Preferably, the frame 100 in this embodiment can access multiple of digital assets or different types of digital assets so that the frame 100 can display different digital assets in a loop on the screen. That is said, the frame 100 can store and collect the digital assets.

In this example, the frame 100 may be mount on the wall, desk, or floor. Preferably, a magnet is mounted on the frame's back surface so that the frame can be attached to the wall or refrigerator without fasteners.

It's notable that although the NFT digital frame contains a read/write processor, the frame is specialized for constant NFTs display visually, rather than expanding to other functions like internet browsing, GPS navigation, phone calls, texting, etc. The frame has a power charging input. Preferably, the display on the screen 102 remains on constantly.

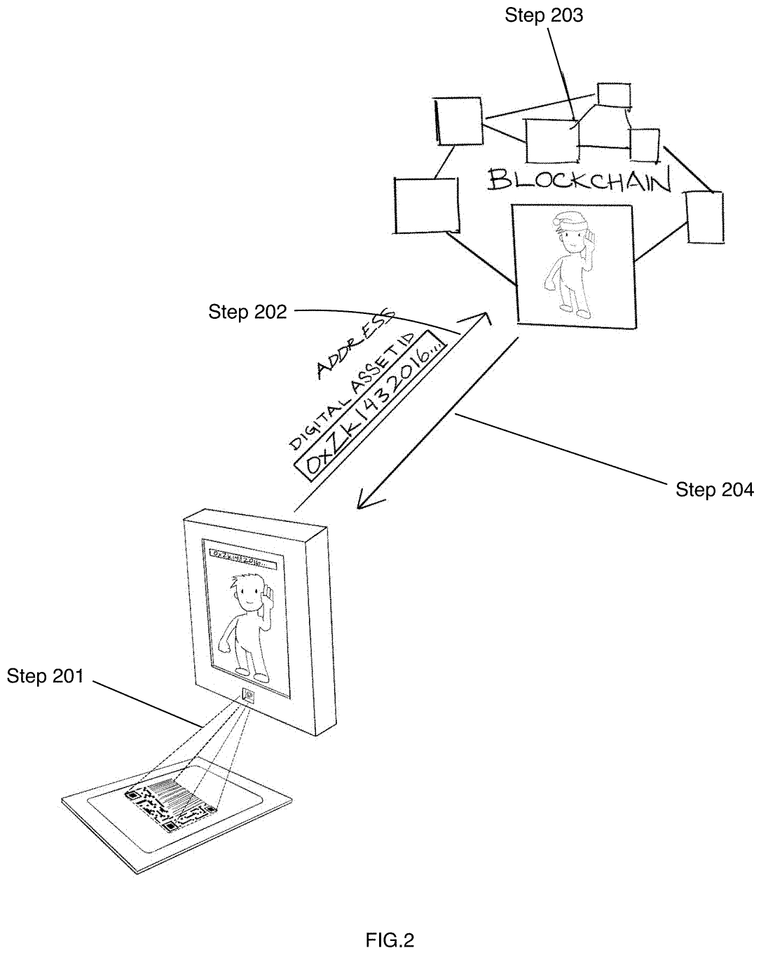

FIG. 2 is a diagrammatic illustration of a representative flowchart for acquisition of a digital asset via scanning in accordance with an embodiment of the present invention. The process for acquisition comprises:

Step 201, identifying a token of a digital asset;

Step 202, retrieving the corresponding digital asset;

Step 203, accessing the digital asset; and

Step 204, displaying of the digital asset.

In this example, the exemplary computation or operation for the acquisition can be performed preferably in the following specified ways:

Step 201, identifying a token of a digital asset. Users can request the token of the digital asset utilizing the NFT digital frame described as FIG. 1 to identify. Scanning, typing, or sending the token, i.e. digital ID or Address of the digital assets. In this embodiment shown in FIG. 2, preferably the token is scanned to perform the identification of the token. The token is exclusively linked to the digital asset stored and encrypted in the decentralized database. The identification operation results in a readable alphanumeric string (the storage address of a NFT digital asset) in a memory.

Step 202, retrieving the corresponding digital asset. After obtaining and analyzing the token, i.e. identifying the binary address of the token, the frame will execute a search in a decentralized database, preferably Blockchain. Please note that the database is substantially decentralized, rather than connecting the Internet centralized Server. The requested digital assets are stored and distributed in the decentralized database ledger, and each of them are mapped into (corresponded to) an exclusive token, where the token and the digital asset are only corresponded to each other. The step 202 operation is aimed to retrieve the encrypted digital asset(s) mapped with the exclusive token(s).

Step 203, accessing the digital asset. After a retrieve operation, only a digital asset mapped into the token is located and targeted. Once the token and targeted digital asset are verified, the “block” for storing the digital asset is decrypted, and consequently the digital asset itself and info thereof (biographic and trade info) are accessed.

Step 204, displaying of the digital asset. Once the digital asset itself and info thereof (biographic and trade info) are unlocked, the digital asset is displayed on the screen of the frame. In this example, if the digital asset integrates some sonic elements, like music, the frame will play the them. If the digital asset includes visual elements, like 3D artwork, video, painting, or picture, the frame will play and exhibit them in different angles.

In another example, the digital frame can access and store multiple digital assets. Optionally, the frame can display multiple digital assets on the screen simultaneously. For example, the displaying screen can be split into different sections, and different digital assets can be displayed in different sections of the split screen simultaneously.

In this example, the decentralized database is a secured and encrypted system for accessing or managing collectible digital assets protected in the database, preferably on a blockchain ledger. The token is collected and distributed in visualization forms of digital address so that they are scanned or identified by the digital frame 100. The database is decentralized, preferable Blockchain ledger. The digital asset “block” is cryptographic and will be verified when an operation of retrieve is running in the Blockchain to decrypt the “block”. The “block” comprises the digital asset itself and supporting digital information thereof. The supporting digital information includes but not limited to the creation date, creator introductions, transaction records, etc.

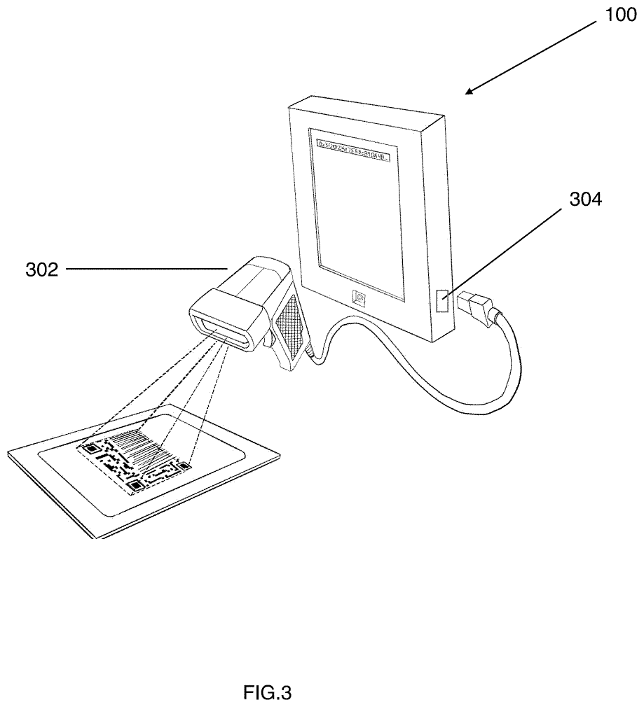

In some embodiments illustrated in FIG. 2 and FIG. 3, the token or code has no limitation about personal identification information. For example, the token may be from public data, i.e., some decentralized data source, including some NFT transaction online platforms. That is to say, the NFT Frame owner can using the frame to scan any token or QR code presented on the platform to view or preview at least partial content of the NFT assets linked into the token or QR code. Thus, all the popular digital NFT assets, treasured collectables, or celebrity digital collections are public to NFT frame owner.

FIG. 3 is a diagrammatic illustration of a representative NFT digital frame connecting an external device, in accordance with an embodiment of the present invention. In this embodiment, the frame 100 connects with a or multiple external devices via a or multiple portal(s). In a preferable example as shown in FIG. 3, a gun-type scanner 302 is connected with the frame 100 via the cable plugging into a portal 304. Besides the gun-type scanner, the external device may be selected from a keyboard, monitor, USB Drive, Memory Drive, Cable, etc. Preferably, the frame 100 has a built-in memory card slot mounted on the edge of the frame. The above external devices may store or transfer the tokens via connection with the frame 100 so that the frame 100 can accomplish the identifying operations via a processor.

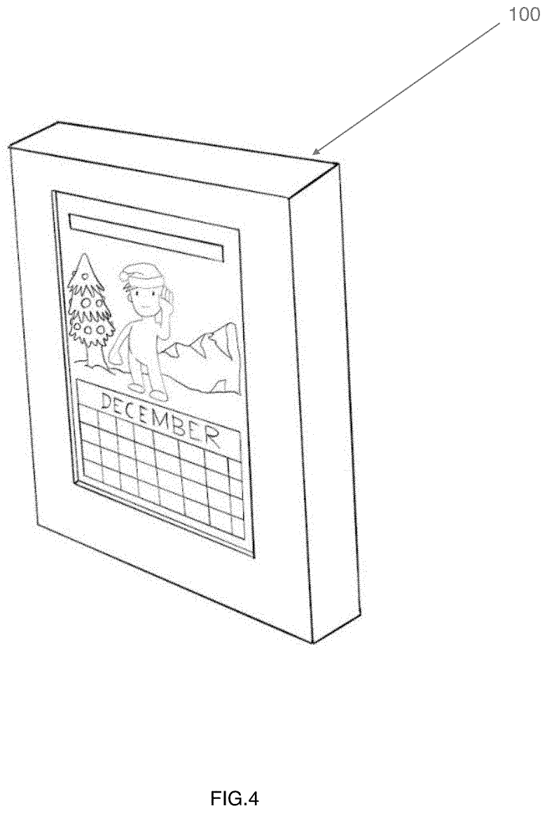

FIG. 4 is a diagrammatic illustration of a representative NFT digital frame displaying a digital calendar on the screen, in accordance with an embodiment of the present invention. In this embodiment the frame 100 can display a digital calendar. Therefore, if needed, the creator can customize the displaying option on digital calendar or assets.

Preferably, the screen 102 of the frame 100 displays a digital calendar for recording and managing information and events of a user. Preferably, the digital calendar contains date, month, year; preferably, the digital calendar contains a clock or digital time.

In one example, the digital calendar contains an interchangeable background, wherein the background is subject to change depending on seasons presented on the frame. For example, when the calendar is showing the winter season, especially in December of the present year, the background is filled with snow, a holiday character, and holiday tree, etc. On the contrary, when the calendar is showing the summer season, the background automatically changes to be filled with some summer-like elements or characters.

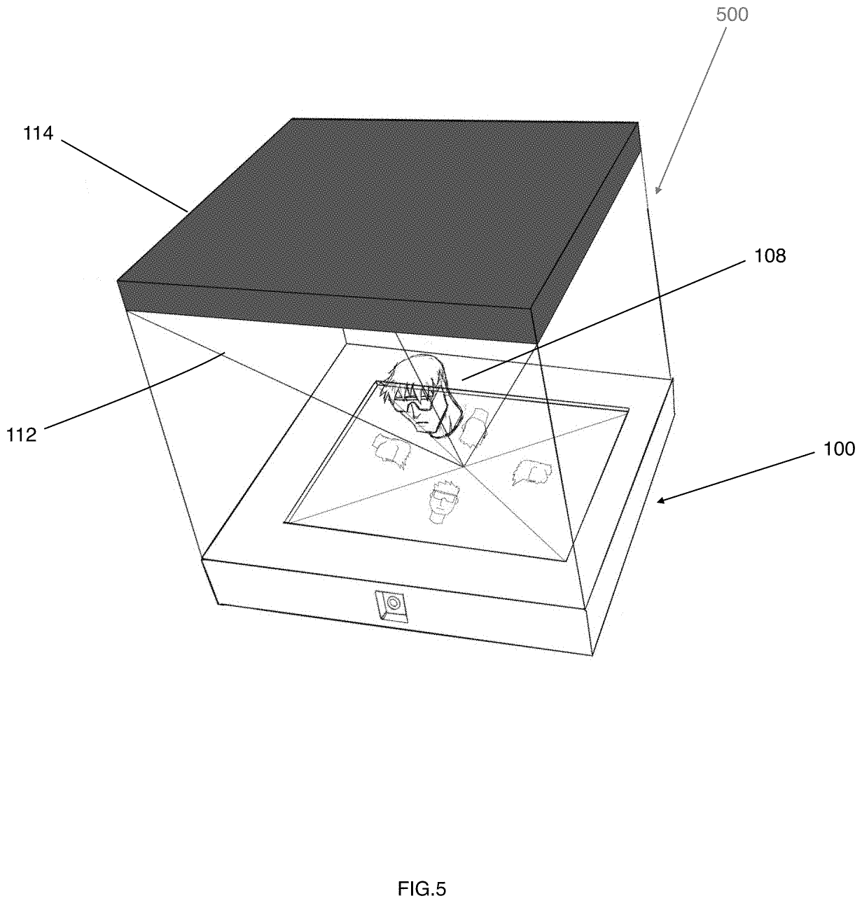

FIG. 5 is a diagrammatic illustration of a representative NFT digital frame hologram assembly displaying a holographic 3D object, in accordance with an embodiment of the present invention. In this embodiment, the assembly 500 integrates a NFT digital frame 100 and a holographic projector 112, introducing a 3D hologram projection in real-time.

In this example, the holographic projector 112 is mounted on the center of the screen of the frame 100 detachably. Preferably the holographic project is shaped into a pyramid, located upside down on the screen. In the operation of hologram, the four triangle split screen of the frame 100 is displaying four images 108 in four different viewing sides for an identical character or object, (i.e. the top, bottom, left, and right perspective views/images), and meanwhile the holographic projector is placed on the center of the screen, consequently resulting in a 3D holographic model 118 floating in space above the frame 100. Such a 3D hologram projection is ready-to-go without any complicated means (i.e. electronic or optical means) required in the present invention. The holographic projector is transparent solid, whose composition is selected from polycarbonates or so.

In this example, preferably the user can place a dark-color cap 114 on the pyramid to reduce the scatter of light and facilitate holographic projection.

It will be apparent to one with skill in the art that the NFT digital frame of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A NFT (Non-Fungible Token) digital frame, the frame comprising:
a display screen to display NFT digital assets, wherein the digital assets are cryptographically secured in a decentralized database;
a scanning unit to scan tokens, wherein storage addresses of the digital assets are mapped into the tokens; and
a processor to identify the tokens and retrieve the data from the decentralized database,
wherein, the tokens are one-to-one corresponded to the digital assets exclusively.

2. The NFT digital frame of claim 1, wherein the digital assets are selected from digital tokens, certificates, paintings, photographs, sculptures, GIFs, videos, audios, or the combination thereof.

3. The NFT digital frame of claim 1, wherein the decentralized database is Blockchain.

4. The NFT digital frame of claim 1, wherein the frame contains a power charge input.

5. The NFT digital frame of claim 1, wherein the tokens are selected from long alphanumeric strings, QR codes, or Barcodes.

6. The NFT digital frame of claim 1, wherein the scanning unit is selected from a built-in camera, QR or Barcode scanner, or handle gun-type scanner.

7. The NFT digital frame of claim 1, wherein further the frame connects with an external device.

8. The NFE digital frame of claim 7, wherein the connection between frame and external is selected from NFC, Bluetooth, Wi-Fi, cable, or a combination thereof.

9. The NFT digital frame of claim 1, wherein further the frame stores one or multiple digital assets, and display the digital assets in a loop on the screen.

10. The NFT digital frame of claim 1, wherein further the frame stores one or multiple digital assets, and display multiple digital assets simultaneously on split-screen.

11. The NFT digital frame of claim 1, wherein further the frame displays the biographical and transaction information of the digital assets on the screen.

12. The NFT digital frame of claim 1, wherein further the frame displays a digital calendar with automatically interchangeable background on the screen.

13. The NFT digital frame of claim 1, wherein further the frame integrates a transparent pyramid on the center of the screen to displays a holographic projection.

14. A method for acquisition of NFT (Non-Fungible Token) digital assets, the method comprising:
identifying a token of a cryptographical digital asset;
retrieving the corresponding digital asset;
accessing the digital asset; and
displaying of the digital asset.

15. The method of claim 14, wherein the identifying comprises scanning, typing, or sending the token of the digital asset to a processor.

16. The method of claim 14, wherein the retrieving includes a search in a decentralized database to locate the corresponding digital asset based on the identified token.

17. The method of claim 14, wherein the token one-to-one corresponds to the digital asset.

18. The method of claim 14, wherein the accessing includes decrypting the digital asset and obtaining the information thereof.

19. The method of claim 14, wherein the displaying includes presenting the digital asset, the information thereof, or combination on a display device.

20. The method of claim 19, wherein the display device is a NFT digital frame of claim 1.
